(19) United States
(12) Patent Application Publication
(10) Pub. No.: US 2024/0400384 A1
(43) Pub. Date: Dec. 5, 2024

(54) METHOD FOR OPERATING A BLAST FURNACE PLANT

(71) Applicant: PAUL WURTH S.A., Luxembourg (LU)

(72) Inventors: Klaus Peter KINZEL, Sandweiler (LU); Gilles KASS, Sanem (LU); Johannes MÜNZER, Mainz-Kastel (DE); Miriam VALERIUS, Saarburg (DE); Fernand DIDELON, BETTEMBOURG (LU)

(21) Appl. No.: 18/696,505

(22) PCT Filed: Sep. 26, 2022
(86) PCT No.: PCT/EP2022/076722

§ 371 Date: Mar. 28, 2024

(30) Foreign Application Priority Data
Sep. 28, 2021 (LU) LU500699

(51) Int. Cl. C01B 3/04; C21B 13/00; C21B 13/02

(52) U.S. Cl. CPC C01B 3/047; C21B 13/0073; C21B 13/029; C01B 2203/0277; C01B 2203/0805; C21B 2100/66

(57) ABSTRACT

A method for operating a blast furnace plant having a blast furnace and an ammonia reforming plant, the method including the steps of feeding a stream of ammonia to the ammonia reforming plant, cracking the stream of ammonia in the ammonia reforming plant to produce a reducing gas, feeding an iron oxide containing charge and the reducing gas into the blast furnace, and reducing iron oxide inside the blast furnace by reaction between the iron oxide containing charge and the reducing gas, where the reducing gas comprises less than 15% of ammonia.

### TECHNICAL FIELD

The present disclosure generally relates to a method for operating a shaft furnace plant as well as to such a shaft furnace installation. In particular, the disclosure relates to a method for operating a blast furnace plant.

### BACKGROUND ART

With the Paris Agreement and near-global consensus on the need for action on emissions, it is imperative that each industrial sector looks into the development of solutions towards improving energy efficiency and decreasing CO₂ output.

In this context, actors in the field of iron metallurgy have developed new approaches in order to reduce the environmental footprint of the blast furnace iron making route. Indeed, despite alternative methods, like scrap melting or direct reduction within an electric arc furnace, the blast furnace (BF) today still represents the most widely used process for steel production, and for many years, efforts have been made to reduce CO₂ emissions from blast furnaces so as to contribute to the general worldwide reduction of CO₂ emissions.

Coke is the main energy input in the blast furnace iron making. From the CO₂ and often also from the economic point of view, this is the less favorable energy source.

Mainly in order to reduce the amount of coke used, a strategy was formulated to recover the blast furnace top gas from the blast furnace, treat it to improve its reduction potential and to inject it back into the blast furnace to aid the reduction process. One method for doing this is reducing the CO₂ content in the blast furnace gas by Pressure Swing Adsorption (PSA) or Vacuum Pressure Swing Adsorption (VPSA). PSA/VPSA installations produce a first stream of gas which is rich in CO and H₂ and a second stream of gas rich in CO₂ and H₂O. The first stream of gas can be used as reduction gas and fed back into the blast furnace. Although PSA/PSA installations allow a reduction of the CO₂ content in the blast furnace gas from about 40 mol-% to about 5 mol-%, they are very expensive to acquire, to maintain and to operate and further they need a lot of space.

In the context of the reduction of CO₂ emissions, considerable efforts are also being made to reduce the usage of carbonaceous fuel for the operation of the blast furnace itself. Substitution of coke by other energy sources, mostly injected at tuyere level, is nowadays widely employed. Due to cost reasons, mostly pulverized coal is injected. Additionally, or alternatively, fuels with increased hydrogen content, in form of hydrocarbons, gaseous hydrogen H₂ or a mixture thereof, are used, mainly in countries with low prices for natural gas. Hydrogen and hydrocarbons being rich in calorific value, have the potential for injection in blast furnace tuyere as an auxiliary fuel.

These auxiliary fuels have a positive impact on the CO₂ emissions from the blast furnace steel making, but their utilization is limited due to process reasons and very often these limits are already reached today. Indeed, the higher the participation of the hydrogen, generally the higher is the CO₂ reduction potential for the blast furnace operation. However, injection of cold H₂ and/or hydrocarbons through the tuyere along with high amount of pulverized coal (PCI) leads to a significant drop in the RAFT (raceway adiabatic flame temperature). In order to increase the RAFT, higher oxygen enrichment is required but limited by the top gas temperature. Therefore, only a relatively small amount of cold H₂ and/or hydrocarbons can be injected into the blast furnace through the tuyeres, which limits the CO₂ saving potential of this technology.

Moreover, in some countries not enough green energy is available to meet the needs of the steelmaking plant. Also, hydrogen production and/or import is very expensive and difficult, requiring specific infrastructures. Thus, there is still a need for alternative methods to supply hydrogen-rich gas to shaft furnaces, in particular to blast furnaces.

### BRIEF SUMMARY

disclosure to the disclosure provides a method for operating a shaft furnace plant as well as a corresponding shaft furnace plant which reduce the CO₂ emissions resulting from operating a shaft furnace and overcome the above-mentioned problems, at least partially.

The present disclosure proposes, in a first aspect, a method for operating a shaft furnace plant comprising a shaft furnace and an ammonia reforming plant, the method comprising the steps of
a. Feeding a stream of ammonia to the ammonia reforming plant;
b. Cracking said stream of ammonia in the ammonia reforming plant to produce a reducing gas;
c. Feeding a metal oxide containing charge, into the shaft furnace;
d. reducing metal oxide inside the shaft furnace by reaction between the metal oxide charge and the reducing gas.

According to the disclosure, the reducing gas comprises less than 15 mol-% of ammonia, preferably less than 10 mol-% of ammonia. Although the method can be applied to the production of other metals like lead or copper from a corresponding metal oxide containing charge, the shaft furnace is preferably used for producing iron (from an iron oxide containing charge), such as e.g. pig iron, slag, direct reduced iron (sponge iron), hot briquetted iron (HBI) or the like.

The present method is particularly adapted to preferred embodiments wherein the shaft furnace is either a direct reduction reactor or a blast furnace. However, this method can be implemented to operate a shaft furnace plant comprising any kind of shaft furnace.

In the context of the present disclosure, a reducing gas refers to a gas able to reduce the metal/iron oxide containing charge while being oxidized, thereby producing metal/iron. In the present text, ammonia cracking may also be referred to ammonia reforming, such that the reducing gas may also be described as cracked ammonia and the unreacted ammonia may be referred to as uncracked or unreformed ammonia.

In the context of the present disclosure, an iron oxide containing charge refers to a material comprising iron hydroxides, iron oxide-hydroxides, iron oxides such as oxides of iron (II) or of iron (III) and or mixed oxides of iron (II) and iron (III). An iron oxide containing charge may refer to iron ores from which metallic iron can be economically extracted. Such iron ores are usually rich in iron oxides in the form of magnetite (Fe₃O₄, 72.4 wt.-% Fe), hematite (Fe₂O₃, 69.9 wt.-% Fe), goethite (FeO(OH), 62.9 wt.-% Fe), limonite (FeO(OH)·n(H₂O), 55 wt.-% Fe) or siderite (FeCO₃, 48.2 wt.-% Fe). An iron oxide containing charge may also comprise direct reduced iron (sponge iron, DRI), hot briquetted iron (HBI), scrap or mixtures thereof.

In the context of the present disclosure, the reforming plant is an ammonia reforming plant (also called an ammonia cracking plant) and comprises at least one reformer configured to reform (i.e. crack) ammonia according to the following reaction: 2 NH₃→N₂+3 H₂. In other words, the reforming plant is where ammonia is cracked.

In embodiments, other reducing and/or carburization agents and/or fuels and the reducing gas or mixtures thereof are fed into the shaft furnace.

In the context of the present disclosure and in the case of the shaft furnace being a blast furnace, typical reducing and carburization agents are coke to be charges at the top of the blast furnace together with the iron bearing material and materials injected at the tuyere of the blast furnace such as pulverized coal, natural gas, coke oven gas, biogas, syngas, charcoal, . . . .

In the context of the present disclosure and in the case of a direct reduction furnace, typical reducing and carburization agents are natural gas and syngas (a gas produced from reforming of a hydrocarbon containing gas, such as natural gas, containing mainly CO, H₂ and in smaller amounts CH₄, N₂, H₂O, CO₂, . . . ).

In embodiments, the ammonia reforming plant may comprise a plurality of reformers, the reformers being arranged in a series or in parallel with regard to each other, or the ammonia reforming plant may comprise a plurality of reformers arranged to form at least two series of reformers, the at least two series being arranged in parallel with respect to each other. In embodiments wherein the ammonia reforming plant comprises more than one reformer, reformers may be identical or different from each other. The exact number, type and arrangement of reformers in the ammonia reforming plant could advantageously be adapted depending on the subsequent feeding of the produced reducing gas to the shaft furnace in order to meet requirements for the produced reducing gas (such as e.g. temperature, residual amount of ammonia).

In another aspect, the present disclosure also proposes a shaft furnace plant comprising:
a shaft furnace; and
an ammonia reforming plant with a gas inlet and a gas outlet, the gas inlet being in fluidic connection with an ammonia source and/or a heat exchanger and the gas outlet being in fluidic connection with the shaft furnace.

Advantageously, the shaft furnace plant is configured to being operated by implementing a method according to the first aspect and as described more in detail below.

The disclosure thus proposes an integrated method and a corresponding plant allowing for operating a shaft furnace with a reduced coke and/or other carbon source rate, with a smaller CO₂ footprint and with an optimized use of existing infrastructures.

The present method proposes the use of ammonia as a new easy and economic energy carrier, ideally applied to the requirement of the steel making industry and more specifically shaft furnaces with the objective to reduce the CO₂ emissions while maintaining most of the existing infrastructure.

Indeed, the inventors have found out that this operating method fits very well in the CO₂ lean energy strategy of countries. The transport of ammonia can be realized in installations very similar to installations dedicated to the transport of liquefied natural gas (LNG) or liquefied petroleum gas (LPG), also existing infrastructures can relatively easily be adapted since the liquefaction temperature of ammonia is −33° C. at ambient pressure. This is thus compatible with typical LPG and/or LNG installations.

In order to reduce CO₂ emissions of a steel plant, ammonia can be used directly as additional fuel gas in burners such as in the burners of the hot stove plant, of the reheating furnaces . . . and of the thermal power plants. When using ammonia directly in burners, one would be facing the problem of NOx emissions related to the burning of the nitrogen rich fuel ammonia. Such problems are avoided when feeding cracked hot ammonia as a reductant (i.e. as a reducing gas) in a shaft furnace, as described above. The remainder of that reducing gas leaving the shaft furnace will add the components H₂, H₂O and N₂ to the exiting top gas. The H₂O being condensed, the exiting top gas will only be richer in N₂ and H₂ with a minimal impact on NOx formation during its burning. It will even have the positive effect that the exiting top gas presents an increased lower calorific value leading to higher efficiency and thus reduced energy consumption of the downstream furnaces and thermal power plant using the top gas exiting the shaft furnace.

A main benefit of the proposed method is therefore to have identified a way to improve the efficiency of the utilization of ammonia in a steel plant and specifically in shaft furnaces in order to further reduce CO₂ emissions.

Another advantage is that production of a syngas with a high hydrogen (H₂) content from ammonia through a reforming (i.e. cracking) process is highly efficient.

Moreover, the cracking of ammonia being a highly endothermic reaction, it requires a lot of energy (i.e. about 2.5 MJ/Nm³ of NH₃) to be carried out. Injecting hot uncracked ammonia in the shaft furnace can therefore thermally be compared with injection of cold N₂ and cold H₂, and would therefore strongly decrease the temperature at the injection point, thereby slowing down the reaction between the reducing gas and the iron oxide containing charge. More coke would need to be charged in order to compensate the cooling effect due to the injection of the uncracked ammonia, thereby negatively affecting the potential for CO₂ emissions reduction. Cracking ammonia outside the shaft furnace therefore prevents the consumption of additional carbon containing reducing agent in to operate the shaft furnace, thus enabling higher reduction in CO₂ emissions of the shaft furnace plant.

Furthermore, as the cracking of the ammonia occurs outside of the shaft furnace, the reaction may be better monitored and controlled, so that an operator may always know the composition (i.e. amount of H₂ and N₂ as well as amount of possible unreacted residual NH₃) of the reducing gas being fed to the shaft furnace, consequently leading to a better control of the iron production.

In embodiments, the ammonia conversion in the ammonia reforming plant is constant over time, thereby ensuring that the reducing gas being fed to the shaft furnace presents the same reducing potential, thus ensuring steady quality and properties of the reducing gas to be injected in the shaft furnace.

Alternatively, the reducing potential and other properties (such as e.g. temperature, pressure) of the reducing gas is dynamically adapted to meet changes in the requirements of the shaft furnace. Such adjustments are of particular interest when the feeding of the iron oxide containing charge is not constant over time, and/or when the quality of the produced iron needs to be adapted during production without having to stop the shaft furnace.

The main advantages and benefits of the operating method and shaft furnace installation according to the disclosure can be summarized as follows:
reuse of existing infrastructure;
cost-efficient transport when compared to hydrogen transport, as ammonia presents a higher energy density on volume basis as hydrogen.
improved efficiency of ammonia utilization in shaft furnace operation.

These and further advantages of the present method for operating a shaft furnace, as well as the presently disclosed shaft furnace plant will be further detailed below.

As mentioned above, the cracking of ammonia is done according to following reaction scheme: 2 NH₃→N₂+3 H₂. The cracking (i.e. reforming) of ammonia necessitates a high activation energy which makes it useful to use a catalyst. At high temperatures, typically at temperatures required for the injection in a shaft furnace, such as e.g. about 700° C. to 1000° C., the ammonia decomposition (i.e. cracking or reforming) can also be performed without using a catalyst. Non-catalytic reforming of ammonia may however require a higher residence time of ammonia inside the at least one reformer of the ammonia reforming plant, and bigger reformer would therefore be needed.

Reforming (i.e. cracking) of ammonia can thus be performed catalytically or non-catalytically.

Furthermore, using a catalyst will allow to supply the endothermal heat required for the ammonia decomposition (i.e. reforming or cracking) at lower temperature. This is all the more important because the cracking (i.e. reforming) requires a very high amount of energy, similar to the energy required for heating ammonia from ambient temperature to about 1000° C. Performing the reforming step at relatively low temperatures, i.e. below about 900° C. or even below about 700° C. will therefore help to increase the thermal efficiency of the process. In embodiments, the cracking of the ammonia in the ammonia reforming plant to produce the stream of reducing gas is therefore advantageously performed catalytically.

Nowadays, development of catalyst for ammonia cracking (i.e. ammonia reforming) is still ongoing. Any kind of catalyst may be used in the present method, such as e.g. a nickel-based catalyst or any catalyst working at high temperature, i.e. at temperatures up to about 1000° C. However, the utilization of catalysts working closer to the possible thermodynamic temperature where high conversion rates of ammonia are given, about 500° C., could advantageously be used in the reformer to increase its thermal efficiency.

Advantageously, the ammonia conversion during the reforming process should be as high as possible, as it means higher concentrations of hydrogen H₂ in the reducing gas and lower concentration of residual ammonia NH₃. This is especially important because decomposition of ammonia being endothermal, it would cool the atmosphere inside the shaft furnace and therefore negatively impact the shaft furnace process. Indeed, a reducing gas having 10 mol-% of ammonia would decrease its temperature by about 40° C. when converting this ammonia adiabatically.

The inventors surprisingly found that it is not problematic to have a residual amount of ammonia in the reducing gas when operating a shaft furnace plant with the present method, nor is the requirement to perform the ammonia reforming (i.e. cracking) at low temperature, since the resulting reducing gas needs to have a high temperature, typically above 800° C. for its injection into the shaft furnace.

As mentioned above, the reducing gas may comprise ammonia, i.e. uncracked (or unreformed) ammonia. Depending on the shaft furnace requirements, the reducing gas may comprise different levels of residual ammonia, such as less than 15 mol-% of ammonia, less than 10 mol-% of ammonia or even less than 5 mol-% of ammonia. As the ammonia reforming process does not need to be complete, it is thus an easy quick win for efficient ammonia utilization in shaft furnaces for reduction of CO₂ footprint.

Preferably the temperature of the reforming process, i.e. the temperature at which the cracking of the ammonia is performed, may substantially correspond to the temperature at which the reducing gas is fed into the shaft furnace.

Preferably the pressure of the reforming process, i.e. the pressure at which the cracking is performed corresponds to the pressure at the shaft level of the blast furnace added by the pressure losses in ducting and in the reformer. The typical pressure level at the entrance of the reformer plant will be below about 15 barg, more specifically below 12 barg.

Advantageously the ammonia reforming plant may comprise a heat exchanger arranged to supply cooling energy to consumers in the steel plant, such as room air conditioning, cooling water cooling and the like and which is resulting from the heating and possibly evaporation of the stream of ammonia provided from the ammonia storage to the at least one reformer.

Alternatively and/or additionally, the ammonia is heated prior to entering the reformer in a heat exchanger with the flue gas coming from the ammonia reformer and/or with a flue gas coming from the combustion of a fuel gas used specifically for that purpose.

The heat exchangers may be of different types, such as tube bundle type, plate heat exchangers, . . . .

In preferred embodiments, the present method further comprises a step of collecting a stream of top gas from the shaft furnace and burning the stream of top gas in the burners of the ammonia reforming plant. In the present text, top gas refers to a gas exiting the shaft furnace at its top, such as e.g. blast furnace gas in embodiments wherein the shaft furnace is a blast furnace, and may also be referred to as shaft furnace gas. Alternatively, or additionally steel plant gases, ammonia itself and/or biofuel such as biogas, biomass, . . . or mixtures thereof may be used in the burners of the ammonia reforming plant.

As mentioned above, the heating and cracking (i.e. reforming) of ammonia uses a lot of energy. Heating ammonia from its gaseous form at about 25° C. to 950° C. and performing its reforming (i.e. cracking) into hydrogen H₂ and nitrogen N₂ requires about 4.5 MJ/Nm³ of ammonia NH₃. Advantageously, this energy can be supplied by the burning of top gas from the shaft furnace in the burners of the ammonia reforming plant, allowing to directly recycle the energy of shaft furnace gas to the shaft furnace for metallurgical reasons instead of using it for electric energy production with a low energy efficiency. As there is no need for a further carbonaceous fuel gas to be burned in the burner of the reforming plant, further CO₂ emissions reduction may be achieved with the present method for operating a shaft furnace plant. Alternatively or additionally steel plant gases, ammonia itself and/or biofuel such as biogas, biomass, . . . or mixtures thereof are used in burners of the ammonia reforming plant.

According to preferred embodiments, the feeding of the reducing gas occurs directly through the shaft of the shaft furnace. In embodiments wherein the shaft furnace is a direct reduction reactor, this means that the reducing gas is preferably injected in the reduction zone of the reactor, i.e. neither in the throat nor in the cooling zone. In embodiments wherein the shaft furnace is a blast furnace, this means that the reducing gas can be injected at the shaft level, i.e. above the hot blast level, preferably within the gas solid reduction zone of ferrous oxide above the cohesive zone. Injection of the produced reducing gas at the shaft level of the blast furnace allows for a significant reduction of the coke rate, i.e. the amount of coke and/or other carbon source per tonne of pig iron produced.

Alternatively or additionally, it is possible to feed the reducing gas at the tuyere level of a blast furnace, preferably at high temperatures after cracking. While injecting the reducing gas through the tuyere may increase the oxygen requirement for the operating of the blast furnace, thereby generally decreasing the possibility for auxiliary fuel addition, the reducing gas containing cracked ammonia can advantageously be injected at tuyere level at high temperatures after the cracking, either with or without O₂ addition for heating to the flame temperature in the raceway, or with or without plasma heating to reach the flame temperature already outside the furnace. Therefore, reducing gas containing cracked ammonia can be injected at tuyere level, with or without injection of (reducing) gas at the lower shaft. Furthermore, reducing gas containing cracked ammonia can be injected at tuyere level with or without injection in the upper level of the shaft of recycled and cooled (condensed) shaft furnace top gas, the reducing gas containing cracked ammonia having previously been directly and/or indirectly heated to 700 to 1000° C.

In preferred embodiments, an auxiliary fuel is fed into the blast furnace in addition to the reducing gas injected at the shaft of the blast furnace. The auxiliary fuel may advantageously be pulverized coal, natural gas, coke oven gas and/or hydrogen. The injection of reducing gas in the shaft of the shaft furnace, and especially of a blast furnace, is allowing a higher tuyere injection of pulverized coal, of natural gas, and especially also of hydrogen, or of other materials. Indeed, shaft injection (or feeding) of cracked ammonia as reducing gas increases the top gas temperature thereby allowing for higher oxygen enrichment at tuyere level, thus allowing for higher auxiliary fuel injection such as PCI, NG, COG and hydrogen. As mentioned above, a cracked ammonia and/or ammonia containing reducing gas may be also added at tuyere level (as auxiliary fuel) with or without O2 addition, with or without additional plasma heating, with or without injection of reducing gas at the lower shaft. Extra amounts of coke can thus be replaced by hydrogen rich auxiliary fuels allowing to further reduce the carbon content of the blast furnace reductant (i.e. reducing the amount of required coke) and consequently the CO2 emissions.

According to some embodiments, a stream of syngas is fed to the shaft furnace in addition to the reducing gas. In such embodiments, the iron reduction is also produced by reaction between the stream of syngas and the iron oxide containing charge.

The stream of syngas may advantageously be produced by reforming an industrial gas (such as e.g. shaft furnace top gas, steam and/or basic oxygen furnaces gas) and a fuel gas (such as e.g. coke oven gas, natural gas, methane and/or biogas).

According to the same or alternative embodiments, HBI and/or scrap may be fed into the blast furnace as part of the iron oxide containing charge.

HBI is an interesting form of energy transport, as it combined an easiness to be transported and a high energy density. Indeed, its compact form facilitates its manipulation and transport so that HBI may be transported using already existing infrastructures. HBI being compacted direct reduced iron, i.e. pre-processed iron ore, the transport of HBI advantageously combines transport of raw material to be fed as the iron oxide containing charge in the blast furnace with transport of energy while avoiding the transport of oxygen that is bound to unreduced ore. Indeed, as HBI is pre-processed iron ore, less energy is needed in the blast furnace to obtain fully processed iron because HBI already has a high content of metallic iron.

In order to achieve important CO₂ savings, the HBI will preferably be produced with green hydrogen. Alternatively it might also be produced from natural gas applying carbon capture to the hydrogen and/or DRI production process.

HBI charged in the blast furnace has the further advantage that relatively low-grade ores can be used for its fabrication. This is due to the fact that the HBI will be melted in the blast furnace where iron and slag will be separated as usual. Lower quality raw materials leading to a higher slag rate and having higher impurities as HBI required for electric steel making with electric arc furnace (EAF) technology can thus be used. In other words, HBI of insufficient quality to be used in EAF technology is advantageously used as part of the iron oxide containing charge to be fed in the blast furnace, thereby further decreasing the energy consumption of the shaft furnace plant as well as its CO₂ emissions.

Moreover, as mentioned above, the feeding of cracked (or reformed) ammonia as reducing gas into the blast furnace allows for a higher temperature of the top gas exiting the blast furnace. This higher top gas temperature allows the use of higher quantities of HBI as charge when compared to blast furnaces being operated not according to the present method, i.e. without the injection of cracked ammonia.

With high HBI charging rates, high CO₂ emission reduction can be achieved. CO₂ emission reduction can also be achieved using CO₂ lean auxiliary fuel such as e.g. COG. Nevertheless, when CO₂ lean auxiliary fuels are used, such as COG, together with HBI, the traditional blast furnace operating methods quickly come to their limits and will not result in a CO₂ emission reduction being the sum of what could be achieved separately for both use (i.e. charging) of HBI on the one hand side and CO₂ lean auxiliary fuel on the other hand side. Indeed, both charging the blast furnace with HBI and using CO₂ lean auxiliary fuel would reduce the top gas temperature of the blast furnace, thus not allowing a combination of both process improvement (HBI charging and use of CO₂ lean auxiliary fuel) to their respective full extent.

Optimal CO₂ savings can be obtained when combining CO₂ lean gaseous fuel injection through the tuyere of a blast furnace with HBI charging of the blast furnace and shaft injection of hot reducing gases, such as the ammonia cracking product (i.e. cracked or reformed ammonia), because shaft injection of reducing gas advantageously increases the top gas temperature, thereby balancing the cooling effect of HBI charging and use of CO₂ lean auxiliary fuel. In particularly preferred embodiments, feeding of cracked (i.e. reformed) ammonia as reducing gas in a blast furnace is combined with feeding of an auxiliary fuel such as e.g. coke oven gas (COG) and with feeding of HBI as part of the iron oxide containing charge to be melted in the blast furnace. According to such embodiments, the shaft injection of reformed ammonia generating a higher top gas temperature enables higher HBI and COG rates due to that higher top gas temperature and thus leads to lower CO₂ emissions, in particular CO₂ emissions reduction up to about 38% can be observed as well as significant productivity increases.

The expression “in fluidic connection” means that two devices are connected by conducts or pipes such that a fluid, e.g. a gas, can flow from one device to another. This expression includes means for changing this flow, e.g. valves or fans for regulating the mass flow, compressors for regulating the pressure, etc., as well as control elements, such as sensors, actuators, etc. necessary or desirable for an appropriate control of the shaft furnace operation as a whole or the operation of each of the elements within the shaft furnace plant.

In the present text, “reformer” means any container, vessel or the like in which a reforming process could be performed, such as a reformer reactor or a reformer vessel.

“Shaft feeding”, “shaft injection”, “feeding . . . into the shaft”, “feeding . . . at the shaft level”, “feeding . . . through the shaft”, “fed at the shaft level”, or “injected at the shaft level” implies the injection of a material (such as e.g. a gas) directly into the shaft of the shaft furnace. In embodiments wherein the shaft furnace is a blast furnace, this implies the injection of a material above the hot blast level, i.e. above the bosh, preferably within the gas solid reduction zone of ferrous oxide above the cohesive zone in a blast furnace.

In the present text, “feeding to the shaft furnace” and “injection to the shaft furnace”, as well as “fed to the shaft furnace” and “injected to the shaft furnace” or “injected into the shaft furnace”, are respectively used as synonym and have the same meaning, which implies the injection of a material into the shaft furnace.

“About” in the present context means that a given numeric value covers a range of values from −10% to +10% of said numeric value, preferably a range of values form −5% to +5% of said numeric value. Unless otherwise indicated, all percentages herein relating to elemental and molecular proportions are expressed as wt.-%, except for gas compositions, wherein the proportions are given in mol-%.

Further details and advantages of the present disclosure will be apparent from the following detailed description of several not limiting embodiments with reference to the attached drawings.

### BRIEF DESCRIPTION OF THE DRAWINGS

Preferred embodiments of the disclosure will now be described, by way of example, with reference to the accompanying drawings in which:

FIG. 1 is a schematic view of an embodiment of a first variant of a shaft furnace plant configured to implement the present shaft furnace operating method; and

FIG. 2 is a schematic view of an embodiment of a second variant of a shaft furnace plant configured to implement the present shaft furnace operating method.

### DESCRIPTION OF PREFERRED EMBODIMENTS

In the following, two different variants of the method for operating a shaft and a shaft furnace plant are shown in relation with the annexed drawings.

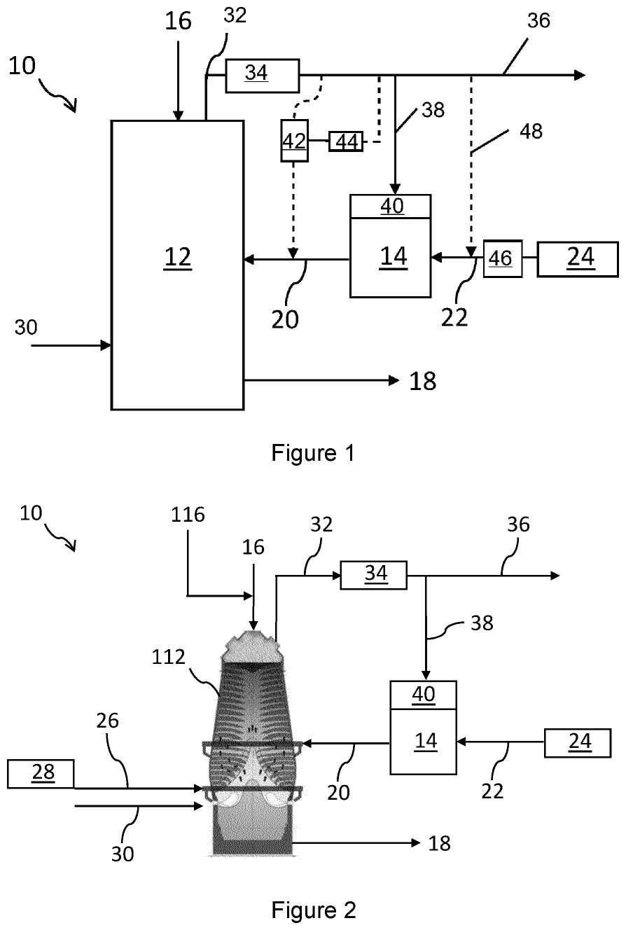

FIG. 1 illustrates an embodiment of a first embodiment of the present method for operating a shaft furnace comprising the reforming (i.e. cracking) of ammonia to produce a first stream of reducing gas (i.e. cracked ammonia) and the injection of the first stream of reducing gas through the shaft of a shaft furnace.

As schematically shown on FIG. 1, a shaft furnace plant 10 comprises a shaft furnace 12 and a reforming plant 14 comprising an ammonia reformer in fluidic connection with the shaft furnace 12. At its top end, the shaft furnace 12 generally receives an iron oxide containing charge 16. At the bottom end of the shaft furnace 12, reduced iron and slag products 18 are extracted.

Auxiliary fuel 30 may be injected in the lower part of the shaft furnace 12. The auxiliary fuel may comprise coke oven gas, natural gas or any other gas commonly used as auxiliary fuel for operating a shaft furnace.

At the top end, shaft furnace gas 32 exiting the shaft furnace 12 is recovered. The recovered shaft furnace gas 32 is generally pre-treated upon exiting the shaft furnace 12. Pre-treatment of the shaft furnace gas 32 comprises first a cooling to reduce its vapor content, and then a cleaning, in particular a removing of dust and/or HCl and/or metal compounds. In the embodiment of FIG. 1, the cooling and cleaning of the shaft furnace gas 32 occurs in a cooling and cleaning unit 34.

Downstream of the cooling and cleaning unit 34, the stream of shaft furnace gas is split in at least two streams. One stream is referred to shaft furnace export gas 36 and may be fed to another unit of a plant comprising the present shaft furnace plant 10. The other stream 38 is used as part of the fuel gas in the burner 40 of the ammonia reformer 14 to produce the necessary energy in order to perform the reforming (i.e. cracking) of ammonia.

Alternatively or additionally, part of the shaft furnace gas may be diverted to separate units like a heat-exchanger 42 and then injected into the shaft furnace 12 and/or to the burners of a reformer 44.

Another part of the shaft furnace gas may be introduced directly into the ammonia reformer 14 via conduits 48 and 22.

The shaft furnace gas (SFG) contains up to approximately 40% of the energy input to the shaft furnace. For the objective of reducing the CO₂ footprint of a shaft furnace-based metal (iron) production, one important strategy is to use as much as possible of this SFG for metallurgical purposes. Hence, the reforming, or cracking, of the ammonia to produce the reducing gas should use as much as possible of the shaft furnace gas in order to improve the CO₂ emission reduction potential from the shaft furnace metal making.

At the shaft level, the shaft furnace 12 receives a reducing gas 20. The reducing gas 20 reacts inside the shaft furnace 12 with the iron oxide containing charge 16 to produce reduced iron oxides and metallic iron. DRI 18 will be extracted from the furnace at its lower side. According to the present embodiment, the reducing gas 20 is produced in the reforming plant 14, namely in the ammonia reformer. The reducing gas 20 is cracked ammonia 22 and comprises N₂ and H₂. The reforming process occurs according to the following reaction:

$$2 {NH}_{3} \to {N}_{2} + 3 {H}_{2} .$$

It may be sustained by a high temperature inside the ammonia reformer and/or by the use of a catalyst, such as e.g. a Ni-based catalyst or any catalyst working at temperatures up to 1000° C., or at least up to 700° C. Ammonia 22 is supplied to the ammonia reformer 14 from a storage tank 24 in fluidic connection with the reformer. In this particular configuration, the ammonia passes from the storage tank 24 through a heat exchanger 46 to heat the ammonia to ambient temperature.

Turning now to FIG. 2, a second embodiment of the present shaft furnace plant 10 and its operating method are presented. In this embodiment, the shaft furnace is a blast furnace 112.

At its top end, the blast furnace 112 generally receives coke (not shown) and ore from a stock house. Ore is commonly referred to as iron oxide containing charge 16. According to the present embodiment, HBI 116 may also be fed to the top end of the blast furnace 112 as part of the iron oxide containing charge 16 to be melted therein.

At the bottom end of the blast furnace 112, liquid pig iron and slag (i.e. iron products) 18 are extracted. The operation of the blast furnace 112 itself is well known and will not be further described herein.

In the lower part of the blast furnace 112, namely at tuyere level, the blast furnace receives the hot blast 26 provided from a hot stove plant 28 comprising a plurality of cowpers, and auxiliary fuel 30. The hot blast 26 may comprise air or an oxygen-rich gas. The auxiliary fuel 30 may be pulverized coal, coke oven gas, natural gas, hydrogen, plastic waste, oil, lignite, ammonia, cracked ammonia or any other gas commonly used as auxiliary fuel for operating a blast furnace.

At the shaft level, which is located above the tuyere level, the blast furnace 112 receives a reducing gas 20. According to the present embodiment, the reducing gas 20 is produced in the reforming plant 14, namely in the ammonia reformer. The reducing gas is cracked ammonia 22 and comprises N₂ and H₂. The ammonia reformer comprises a burner 40 that is supplied at least with a fuel gas.

The reducing gas 20, with its high content of hydrogen is injected into the blast furnace 112 at the shaft level.

At the top end, blast furnace gas 32 exiting the blast furnace 112 is recovered. The recovered blast furnace gas 32 is generally pre-treated upon exiting the blast furnace 112. Pre-treatment of the blast furnace gas 32 comprises first a cooling to reduce its vapor content, and then a cleaning, in particular a removing of dust and/or HCl and/or metal compounds. In the embodiment of FIG. 2, the cooling and cleaning of the blast furnace gas occurs in a cooling and cleaning unit 34. Alternatively, separate units could be used, a first unit preforming a cooling, and a second unit (or a plurality of second units) performing the cleaning or vice versa.

Downstream of the cooling and cleaning unit 34, the stream of blast furnace gas is split in at least two streams. One stream is referred to blast furnace export gas 36 and may be fed to another unit of a steel making plant comprising the present shaft furnace plant 10. The other stream 38 is used as part of the fuel gas in the burner 40 of the ammonia reformer 14 to produce the necessary energy in order to perform the reforming (i.e. cracking) of ammonia.

The blast furnace gas (BFG) contains up to approximately 40% of the energy input to the blast furnace. For the objective of reducing the CO₂ footprint of a blast furnace-based steel production, one important strategy is to use as much as possible of this BFG for metallurgical purposes. Hence, the reforming, or cracking, of the ammonia to produce the reducing gas should use as much as possible of the blast furnace gas in order to improve the CO₂ emission reduction potential from the blast furnace iron making.

A shaft furnace plant 10 as described above with reference to FIG. 2 can be operated to produce iron according to the method described herein. Table 1 is comparing a classical operation (reference case) of a blast furnace and an operation of a blast furnace with cracked ammonia (i.e. a first stream of reducing gas) injection according to three embodiments of the present method.

TABLE 1

| | | | | | Case 3: |
|---|---|---|---|---|---|
| | | | | Case 2: | cracked |
| | | | | cracked | ammonia |
| | | | Case 1: | ammonia | injection + |
| | | | cracked | injection + | COG |
| | | Reference | ammonia | COG | injection + |
| Item | Unit | case | injection | injection | HBI |
| Dry rates (per t of | | | | | |
| hot metal) | | | | | |
| HBI | kg/t | 0 | 0 | 0 | 407 |
| Total coke rate | kg/t | 301 | 220 | 202 | 201 |
| Injection coal rate | kg/t | 192 | 192 | 181 | 91 |
| Injection COG to | Nm³/t | 0 | 0 | 115 | 135 |
| tuyere | | | | | |
| Injection cracked | Nm³/t | 0 | 400 | 400 | 400 |
| ammonia to shaft | | | | | |
| Blast conditions | | | | | |
| Natural dry blast | Nm³/tHM | 830 | 744 | 412 | 381 |
| volume | | | | | |
| O₂ enrichment | Nm³/tHM | 63 | 50 | 130 | 97 |
| Flame temperature | ° C. | 2239 | 2162 | 2149 | 2126 |
| Top gas | | | | | |
| CO | mol-% | 24.32 | 18.6 | 20.5 | 22.1 |
| CO₂ | mol-% | 24.22 | 18.8 | 21.7 | 12.8 |
| H₂ | mol-% | 3.8 | 15.1 | 22.8 | 29.7 |
| N₂ | mol-% | 47.7 | 47.6 | 34.9 | 35.4 |
| Temperature | ° C. | 125 | 220 | 169 | 162 |
| Volume (dry) | Nm³/tHM | 1401 | 1455 | 1268 | 1187 |
| Lower calorific value | kJ/Nm³ | 3479 | 3969 | 5056 | 5997 |
| (dry) | | | | | |
| CO₂ | | | | | |
| CO₂ emissions | kg/tHM | 1973 | 1634 | 1528 | 1221 |
| CO₂ emissions | % | | 17 | 23 | 38 |
| reduction (with respect | | | | | |
| to reference case) | | | | | |

For the calculations of the CO₂ emissions in the different cases, the following emission factors have been considered for the different input materials (Table 2).

TABLE 2

| Material | CO₂ emission | |
|---|---|---|
| Coke | 4.17 | kgCO₂/kg |
| Pulverized coal | 2.79 | kgCO₂/kg |
| Sinter | 0.196 | kgCO₂/kg |
| HBI | 0 | kgCO₂/kg* |
| COG | 0 | kgCO₂/Nm³ |
| BFG export | 0 | kgCO₂/Nm³** |

*Usually there is some carbon in HBI (about 1.5 wt.-%). In this case, green HBI was used which has been produced carbon free.
**The CO₂ emissions are already attributed to the hot metal

In the reference operation, the blast furnace uses only coke and pulverised coal injection at the tuyere, whereas in case 1, cracked ammonia is additionally injected at the shaft level (i.e. through the shaft) of the blast furnace. One can see in case 1 that by injecting 400 Nm³/tHM (Nm³/t of hot metal) of cracked ammonia through the shaft, a high decrease of the coke rate is possible, from 301 (for the reference) to 220 kg/tHM (for case 1). CO₂ emissions decrease from 1973 (for the reference) to 1634 kg/tHM (for case 1), allowing for 17% of CO₂ emission reduction. Rates expressed as “/tHM” refer to per tonne (metric ton) of hot metal produced by the shaft furnace. “Nm³” refers to normal cubic meter to indicate a volume of 1 cubic meter of gas at normal conditions, i.e. at a temperature of 0° C. (273.15 K) and an absolute pressure of 1 atm (101.325 kPa).

In case 2 (Table 1) cracked ammonia is injected at the shaft level of the blast furnace (as in case 1) and coke oven gas (COG) is injected through a tuyere of the blast furnace. When increasing the injection of auxiliary fuel (such as COG), the enrichment of oxygen must be increased in order to maintain the flame temperature. The flame temperature is usually higher than 2000° C. with PCI and higher than 1800° C. without PCI.

Increasing the oxygen enrichment in the blast furnace signifies reducing the amount of natural blast (air) that will be used in the blast furnace. In consequence the overall amount of hot blast entering the blast furnace is decreased, from 830 (for the reference) to 412 Nm³/tHM (for case 2).

As one can see from case 2 of Table 1, simultaneous COG injection and pulverised coal injection is possible and allows for a sufficient top gas temperature of about 169° C. COG injection allows for a further reduction of the coke rate, from 220 (for case 1) to 202 kg/tHM (for case 2). Related CO₂ emissions thereby decrease from 1634 (for case 1) to 1528 kg/tHM (for case 2), corresponding to an additional 6% of CO₂ emission reduction. With respect to the reference case, CO₂ emissions decrease by 23% in case 2.

In the last case displayed in Table 1 (case 3), HBI is fed as part of the iron oxide containing charge additionally to the injection of cracked ammonia and COG. Feeding HBI allows to reduce the coal rate (i.e. the rate for pulverized coal injection) while maintaining substantially the same coke rate with respect to case 2 (202 vs 201 kg/tHM), which is expected and corresponds to the minimum coke rate with which a blast furnace can be operated allowing to ensure the required permeability for the gas-solid-liquid reactor. It can be seen that the CO₂ footprint is further reduced due to the overall reduced carbon input. CO₂ emissions are only 1221 kg/tHM, corresponding a 38% of CO₂ emissions reduction with respect to the reference case.

When looking at Table 1, it can be seen that replacing some coke by cracked ammonia increases the lower calorific value of the top gas, allowing for increased efficiency in downstream utilisation of the top gas (i.e. blast furnace gas) in power plant and/or other furnaces. Further reduction of the coke rate by injection of coke oven gas (COG) as auxiliary fuel and/or of HBI as iron oxide containing charge allows for a further increase in the lower calorific value of the top gas.

While the disclosure has been illustrated and described in detail in the drawings and foregoing description, such illustration and description are to be considered illustrative or exemplary and not restrictive; the disclosure is not limited to the disclosed embodiments. Other variations to the disclosed embodiments can be understood and effected by those skilled in the art in practicing the claimed disclosure, from a study of the drawings, the disclosure, and the appended claims.

1.-18. (canceled)

19. A method for operating a blast furnace plant comprising a blast furnace and an ammonia reforming plant, the method comprising the steps of:
a. Feeding a stream of ammonia to the ammonia reforming plant;
b. Cracking said stream of ammonia in the ammonia reforming plant to produce a reducing gas;
c. Feeding an iron oxide containing charge and the reducing gas into the blast furnace;
d. Reducing iron oxide inside the blast furnace by reaction between the iron oxide containing charge and the reducing gas,
wherein the reducing gas comprises less than 15% of ammonia.

20. The method according to claim 19, wherein the cracking at step b) is performed catalytically.

21. The method according to claim 19, further comprising the step of collecting a stream of top gas from the blast furnace and burning said stream of top gas in burners of the ammonia reforming plant.

22. The method according to claim 19, further comprising the step of feeding other reducing and/or carburization agents and/or fuels and the reducing gas or mixtures thereof into the blast furnace.

23. The method according to claim 19, wherein steel plant gases, ammonia and/or biofuel comprising biogas, biomass or mixtures thereof are used in burners of the ammonia reforming plant.

24. The method according to claim 19, wherein energy for heating, and/or evaporation of the ammonia to ambient temperature is used to cover cooling needs in the steel plant comprising air conditioning and/or cooling of cooling water.

25. The method according to claim 19, wherein the blast furnace comprises a shaft and the feeding of the reducing gas occurs directly through the shaft of the blast furnace.

26. The method according to claim 19, wherein an auxiliary fuel, reducing and/or carburization agent is fed into the blast furnace in addition to the reducing gas.

27. The method according to claim 26, wherein the auxiliary fuel is pulverized coal, natural gas, coke oven gas, biogas, syngas, ammonia, cracked ammonia, hydrogen and/or mixtures thereof fed to the blast furnace at tuyere level.

28. The method according to claim 19, wherein a stream of syngas is fed to the blast furnace in addition to the reducing gas, and wherein iron products are also produced by reaction between the stream of syngas and the iron oxide containing charge.

29. The method according to claim 28, wherein the stream of syngas is produced by reforming an industrial gas and a fuel gas.

30. The method according to claim 29, wherein hot briquetted iron and/or scrap is fed into the blast furnace as part of the iron oxide containing charge.

31. A blast furnace plant, configured for implementing the method according to claim 19, the blast furnace plant comprising:
a blast furnace; and
an ammonia reforming plant with a gas inlet and a gas outlet, the gas inlet being in fluidic connection with an ammonia source and/or a heat exchanger and the gas outlet being in fluidic connection with the blast furnace.

32. The blast furnace plant according to claim 31, wherein a top of the blast furnace is in fluidic connection with burners of the ammonia reforming plant.
